(19) United States
(12) Patent Application Publication
(10) Pub. No.: US 2016/0285911 A1
(43) Pub. Date: Sep. 29, 2016

(54) CONTEXT SENSITIVE MULTI-MODE AUTHENTICATION

(71) Applicant: Intel Corporation, Santa Clara, CA (US)

(72) Inventors: Edward I. Goldman, Folsom, CA (US); Eddie Balthsar, Folsom, CA (US); Hong Li, El Dorado Hills, CA (US); Igor Tatourian, San Jose, CA (US)

(73) Assignee: Intel Corporation, Santa Clara, CA (US)

(21) Appl. No.: 14/361,724

(22) PCT Filed: Dec. 24, 2013
(86) PCT No.: PCT/US2013/077657

§ 371 Date: May 30, 2014

(51) Int. Cl. H04L 29/06

(52) U.S. Cl. CPC H04L 63/20; H04L 63/08; H04L 63/10

(57) ABSTRACT

Generally, this disclosure provides technology for authenticating a client device or a user thereof to an authentication agent that enforces authentication operations to a protected resource on the user's behalf with a contextually sensitive security procedure (CSSP). In some embodiments, the technology includes a client device having a multimode authentication module (MAM) thereon, which may function to determine which of a plurality of security policies in a CSSP is being enforced by an authentication agent with respect to a particular protected resource. Once the security policy is determined, the MAM may cause the authentication agent to perform authentication operations on the user's or client device's behalf, associated with the policy in a transparent or substantially transparent manner.

### FIELD

The present disclosure relates to technologies for facilitating user authentication and, more particularly, to technologies for facilitating user authentication in complex system architectures employing contextually sensitive security procedures.

### BACKGROUND

Complex enterprise networks often host a variety of protected resources (applications, data, etc.) across a variety of different networks. Access to any or all of such networks, their respective components, and their hosted resources may be protected by one or more security procedures. A user wishing to gain access to such a network or its hosted resources must comply with the security procedure before access to the network and/or resource will be granted. Such security procedures may utilize contextual modifiers to alter or completely change the authentication process required by the procedure, depending on the context from which the access request is made For the sake of clarity, such a procedure is referred to herein as a contextually sensitive security procedure, or CSSP.

As one relatively simple example, a contextually sensitive security procedure may require performance of different authentication operations depending on where a request to access a protected resource originates. Thus for example, a CSSP may require performance of a first set of authentication operations when a user attempts to access a protected resource from an internal enterprise network (e.g., at a user's place of work), but may require the execution of a second, different set of authentication operations if access to the resource is attempted from an external network (e.g., from the user's home). Of course, a variety of context modifiers may be used in a CSSP, and they are not limited to location and/or type of network from which a request to access a protected resource is made.

Any or all of the authentication operations enforced by a CSSP may require the input of credentials such as passwords, biometric information, etc., and may require the performance of operations in a certain sequence. These credentials and operations may differ from one set of authentication operations to another. As a result, end users of complex/highly secure networks are often required to remember a variety of contextually sensitive procedures that may be required to access a desired resource using numerous sets of different credentials. This can present an undesirable user experience, particularly in highly secure systems which may only allow access to a given resource for a relatively short period of time before user re-authentication is required. While existing single sign on (SSO) solutions and secure password storage solutions such as password vaults can alleviate some of the burden of remembering different login credentials, such systems do not provide a user transparent mechanism for authenticating users to a system employing a contextually sensitive security procedure. Indeed while a password vault can provide secure storage for passwords and reduce the burden on users to remember multiple passwords, users thereof still have to retrieve the passwords from the vault and authenticate to an application every time it is launched.

In addition, existing SSO solutions may only work with a set of federated applications or services, which may be managed by the same system such as an enterprise Active Directory. As a result, these solutions may not be flexible enough to support the activities of many users today who, after logging onto a computing device, may need to provide login credentials that span across work, leisure, finance, health, social networking, etc., from different applications, websites, and service providers, using different authentication models.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIG. 1 is a top level diagram of one example of a context sensitive multimode authentication system consistent with the present disclosure;

FIG. 2A is a block diagram of one example of a client device consistent with the present disclosure;

FIG. 2B is a block diagram of one example of a multimode authentication module (MAM) consistent with the present disclosure.

FIG. 3 is a flowchart of exemplary operations of one example of a method of authenticating a user with a multi-mode authentication module consistent with the present disclosure.

FIG. 4 depicts the structure of one example of a contextually sensitive security procedure consistent with the present disclosure.

Although the following Detailed Description will proceed with reference being made to illustrative embodiments, many alternatives, modifications, and variations thereof will be apparent to those skilled in the art.

### DETAILED DESCRIPTION

The terms “contextually sensitive security procedure” and “CSSP” are interchangeably used herein to refer to a security procedure which governs access to a protected resource with a plurality of different security policies, any or all of which may require performance of one or more authentication operations that may be enforced by the authentication agent depending on relevant contextual information. While CSSP of various forms are contemplated, in one example a CSSP may be structured in the form of a database or other data structure that includes a record of resources to be protected by an authentication agent (hereinafter, “protected resources”). The record may correlate each protected resource to a plurality of contextual modifiers, with each contextual modifier correlated to a security policy. As will be described later, each contextual modifier may correlate to one or plurality of contextual factors, which individually or collectively may define a contextual scenario. In any case, each security policy may specify at least one authentication operation that must be met to grant a user access to the resource when one or more of the contextual modifiers is “true.”

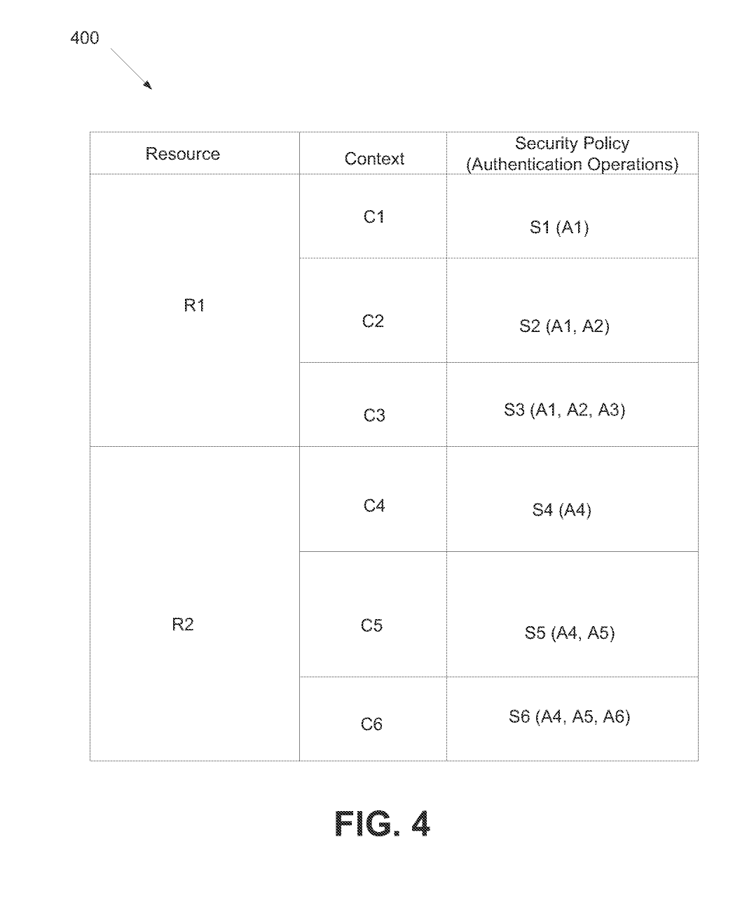

To further illustrate this concept reference is made to FIG. 4, which depicts one example of the structure of a CSSP that may be used in accordance with the present disclosure. As illustrated, CSSP 400 is in the form of a database or other data structure that includes a record of a plurality of protected resources, R1, R2, etc., access to which is governed by enforcement of CSSP by an authentication agent (not shown). Each protected resource (e.g., R1, R2, etc.) is correlated with a plurality of contextual modifiers (e.g., C1, C2, C3 . . . C6, etc.), which are in turn correlated with a one or more security policies (e.g. S1, S2, S3 . . . S6, etc.). Each of the security policies specifies at least one authentication operation (e.g., A1, A2, A3 . . . A6, etc.) which must be met before user access to the relevant resource will be granted, if a correlated context modifier is “true.”

Non-limiting examples of contextual modifiers that may be used include user location at the time a request to access a resource is made, verification of user identity, user security level, successful completion of other (e.g., pre-requisite) authentication procedures, user type (e.g., employee/non-employee), user presence or absence at the device submitting the request, the type of network (internal, external, trusted, untrusted, secure, unsecure, etc.), the time at which a request to access the protected resource is made, the location from which the request to access the protected resource is made, the security level of the protected resource, the type of credentials supplied by a user (hard token, soft token, username and password, etc.), device authorization (e.g., whether a client device is permitted to perform authentication operations in association with a CSSP, combinations thereof, and the like. Such contextual modifiers are of course exemplary, and any suitable contextual modifiers can be used. Similarly, combinations of contextual modifiers (e.g., C1, C2, C3, etc.) can be used to define contextual scenarios which may be correlated with one or more security policies (e.g., S1, S2, S3 and/or specific authentication operations), as desired.

As noted previously security policies (e.g., S1, S2, S3) may be associated with one or more contextual modifiers and/or scenarios, and may require the successful performance of one or a combination of authentication operations (A1 . . . A6, etc.) before access to a resource governed by the CSSP will be granted. Any suitable authentication operation may be used as authentication operations within a security policy. Non-limiting examples of authentication operations include the submission of credentials (e.g. username, password, biometric information, etc.), validation of secure token information, verification of user presence, verification of user identity, combinations thereof, successful completion of other security policies (e.g., a pre-requisite policy governing access to a system which hosts a protected resource for which access is requested), movement to a secure network, establishment of a secure channel between a client device and a secure network, combinations thereof, and the like.

By way of example, R1 may be a secure enterprise network hosting a protected application, R2. R1 and R2 may each protected by a CSSP that associates each resource with a variety of contextual modifiers and associated security policies. As shown in FIG. 4 for example, the CSSP may associate R1 with contextual modifiers C1, C2, C3, wherein each contextual modifier is associated with a security policy, i.e., S1, S2, and S3, respectively.

For the sake of illustration and example only, C1 may be a contextual modifier that is considered “true” when a user requesting access to R1 is an employee of the company that owns R1, i.e., the enterprise network. C2 may be a contextual modifier that is considered “true” when the user requesting access is a guest, (e.g., a non-employee). And C3 may be a contextual modifier that is considered “true” when a request to access to R1 is made from outside the enterprise network, e.g., from a user's home network, a public access point, or the like. With this in mind, CSSP 400 may correlate context modifiers C1, C2, and C3 with security policies, S1, S2, S3, respectively. Therefore if contextual scenario C1 is true when access to R1 is requested, CSSP 400 will require successful performance of security policy S1 and its associated authentication operations (A1) before access to R1 is granted. Similarly if contextual scenarios C2 and/or C3 are true when access to R1 is made, CSSP 400 will require successful performance of security policies S2 and/or S3 and their associated authentication operations, respectively, before access to resource R1 is granted. As may be appreciated, if combinations of C1, C2, and C3 are true when access to R1 is requested, CSSP 400 may require successful completion of a corresponding combination of S1, S2, and S3.

Similarly, CSSP 400 may govern access to protected application R2 by correlating it to a variety of contextual modifiers (C4 . . . C6) and associated security policies (S4 . . . S6 and their respective authentication operations A4 . . . A6). Because R2 is hosted on R1, context modifiers C4 . . . C6 and/or security policies S4-S6 may each condition access to R2 on user access to R1. The context modifiers and security policies governing access to R1 may therefore be considered pre-requisites that must be successfully completed (along with one or more of S4, S5, or S6) before access to R2 may be granted.

Of course, FIG. 4 is but one example of how a CSSP may be structured, and it should be understood that any number of different CSSP structures may be successfully used in connection with the present disclosure. For example, a CSSP may be structured such that protected resources are correlated with a plurality of contextual modifiers and a plurality of different security policies. In contrast to CSSP 400, which correlates security policies S1, S2, S3, etc. with contextual modifiers that define specific contextual scenarios, a CSSP may be configured such that different security policies are triggered when certain threshold numbers of contextual modifiers are true at the time a request to access a protected resource is made. Similarly, a CSSP may be configured such that performance of certain authentication operations is conditioned on whether one or more threshold number of contextual factors are true at the time a request to access a protected resource is made.

As explained in the background and suggested by the foregoing description of FIG. 4, implementation of a CSSP may require a user to engage in cumbersome and/or inconvenient manual performance of a variety of authentication operations. This can present an annoying user experience, particularly if a user requesting access to a protected resource has previously been authenticated using another strong authentication procedure such as biometric authentication.

With the foregoing in mind, one aspect of the present disclosure relates to a multi-mode authentication system that is operable to transparently authenticate a user to a secure system that employs one or more contextually sensitive security procedures (CSSP) to govern access to one or more protected resources. The term “transparent” when used in connection with the performance of authentication operations (e.g., by a multimode authentication module) means that authentication operations required by a CSSP may be performed without the inputs from a user. Similarly, the term “substantially transparent” when used in connection with the performance of authentication operations mean that authentication operations required by a CSSP may be performed with relatively few (e.g., one, two, etc.) inputs from a user, e.g., as may be required when information needed to comply with an authentication operation is not known to the module, and/or the CSSP requires compliance with secondary authentication operations (e.g., the entry of a one-time use password).

While the present disclosure focuses on a specific use case in which a CSSP is used to protect resources (e.g., data, documents, applications, etc.) maintained on a secure network (e.g., an enterprise network), it should be understood that the principles of the present disclosure may extent to other contexts as well. For example, the technologies described herein may be used to transparently authenticate a user to a CSSP governing access to a secure network itself, a secure offline device (e.g., a secure computer system, mobile device, etc.), combinations thereof, and the like.

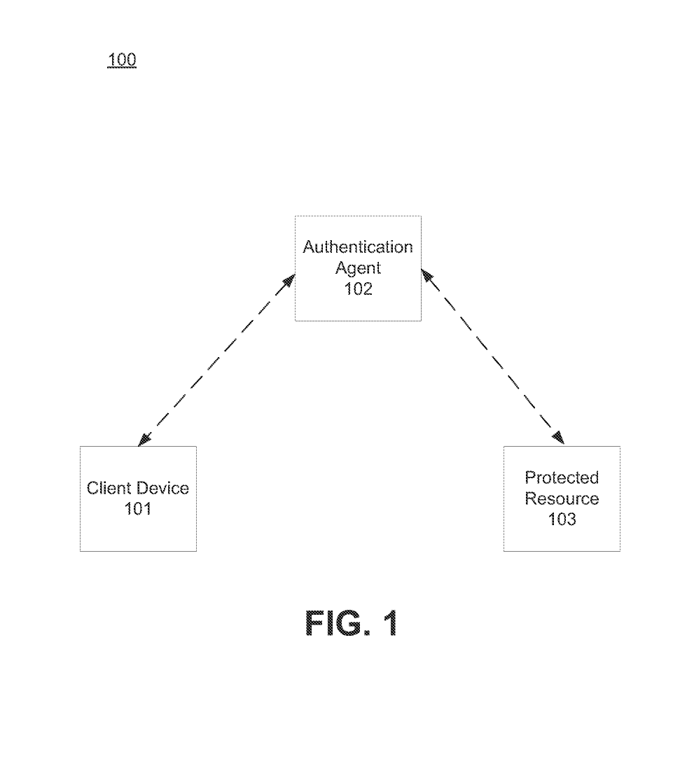

Reference is therefore made to FIG. 1, which illustrates a top level diagram of a multimode authentication system 100 consistent with the present disclosure. As shown, system 100 includes client device 101 and authentication agent 102, wherein authentication agent 102 governs access to protected resource 103 with a CSSP.

Client device 101 may be any of a wide variety of electronic devices. Non-limiting examples of suitable client devices that may be used in accordance with the present disclosure include any kind of mobile device and/or non-mobile device, such as cameras, cell phones, computer terminals, desktop computers, electronic readers, facsimile machines, gaming devices/consoles, kiosks, netbook computers, notebook computers, internet devices, payment terminals, personal digital assistants, media players and/or recorders, servers, set-top boxes, smart badges, smart phones, tablet personal computers, ultra-mobile personal computers, wired telephones, combinations thereof, and the like. Without limitation, the client devices described herein are preferably in the form of one or more cell phones, computer terminals, desktop computers, laptop computers, smart phones, smart badges, and tablet personal computers.

Authentication agent 102 may be in the form of hardware, software, or a combination of hardware and software that is configured to govern access to one or more resources, such as protected resource 103. Non-limiting examples of authentication agents that may be used in accordance with the present disclosure include hardware and/or software firewalls, authentication systems such as authentication servers, authentication kiosks, authentication sensors, trusted processing environments (e.g., a trusted execution environment, a secure enclave, etc.), combinations thereof, and the like. In general, authentication agent 102 may govern access to a resource using one or more contextually sensitive security policies. In such instances, authentication agent 102 may be configured to receive requests to access protected resource 103, to determine a relevant contextually dependent security policy to govern access to protected resource, and to issue authentication requests consistent with the contextually dependent security policy and/or authentication operations associated therewith.

Protected resource 103 may be any type of resource over which access or control may be limited by authentication agent 102 or, more particularly, a CSSP enforced by authentication agent 102. Non-limiting examples of resources that may be used as protected resource include computer networks, network applications, digital information (e.g., photos, videos, documents, audio files, software, etc.), computer systems, combinations thereof, and the like.

Client device 101, authentication agent 102, and/or protected resource may be in wired or wireless communication with one another, using one or more predetermined wired or wireless communication procedures. For example, client device 101, authentication agent 102, and/or protected resource 103 may communicate with one another via one or more wired or wireless networks, such as but not limited to a wireless network complying with any existing or future 802.11 or other wireless standard, a cellular network, a near field communication network, a ZigBee network, a BLUETOOTH® network. Alternatively or additionally, client device 101, authentication agent 102, and/or protected resource 103 may communicate via a local area network (LAN), a wide area network (WAN), the internet, or a combination thereof.

For the sake of clarity and ease of understanding, FIG. 1 illustrates a relatively simple system in which a single authentication agent 102 governs access to one protected resource 103. It should be understood that this illustration is exemplary only, and that systems of varying degrees of complexity are envisioned by the present disclosure. Indeed, the present disclosure envisions systems in which multiple authentication agents may govern access to a plurality of protected resources.

By way of example, the present disclosure envisions systems in which a first authentication agent employs a first CSSP to govern access to a first resource such as a computer network, and a second authentication agent employs a second CSSP to govern access to protected resources on the computer network. In such instances, user access to the protected resources on the computer network would be predicated on successful authentication of the use through the first CSSP, as well as the second CSSP, as generally described above in connection with FIG. 4. Similarly, the present disclosure envisions systems in which a single authentication agent governs access to a plurality of protected resources, wherein access to one or more of the protected resources may or may not be predicated on access to other (pre-requisite) protected resources. In such instances, whether or not a user has access to relevant prerequisite resources may be a contextual factor in the CSSP governing access other protected resources.

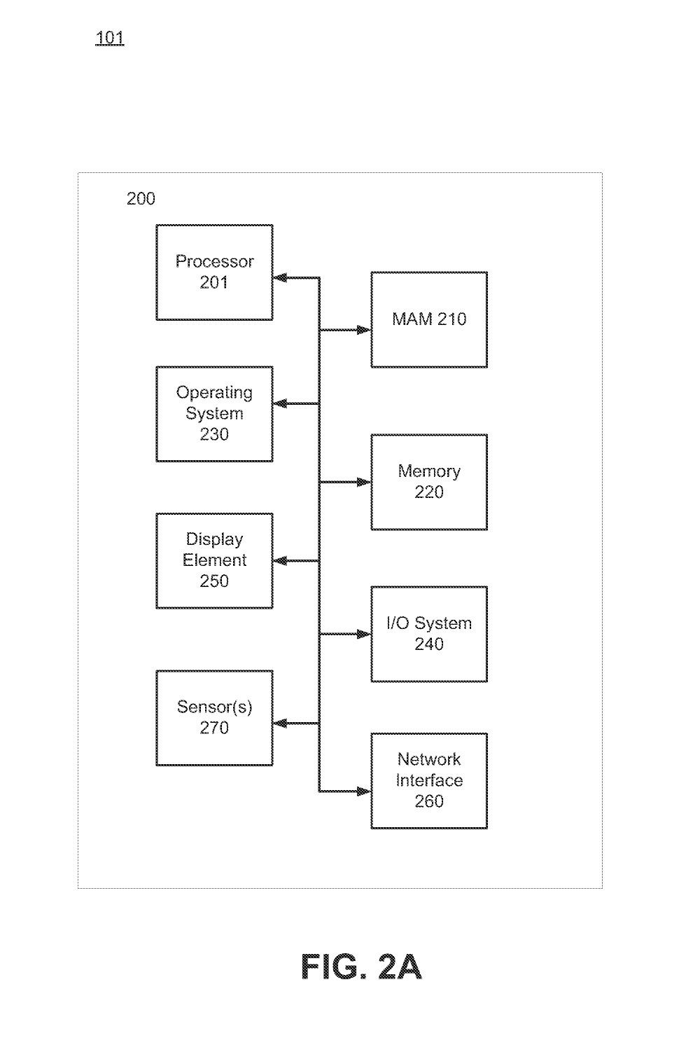

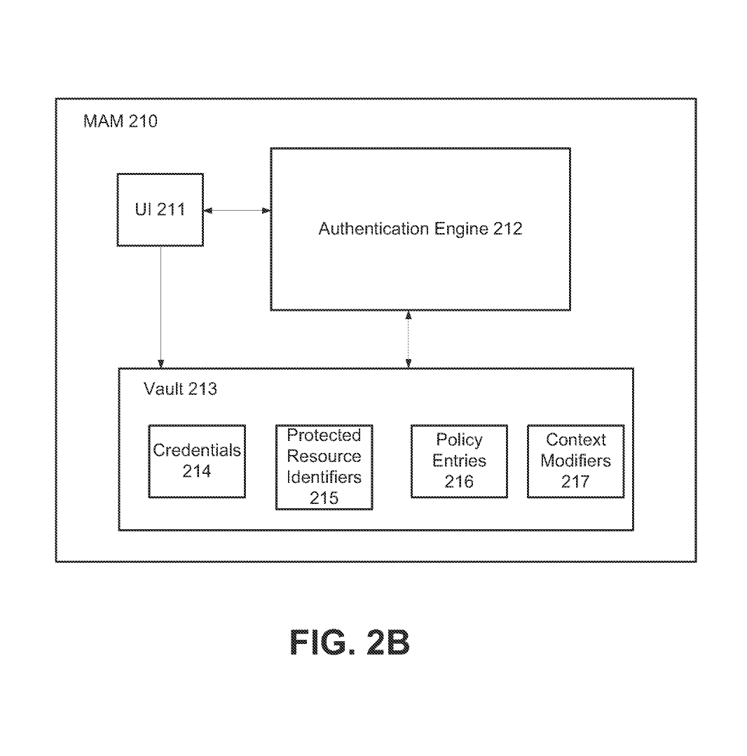

In operation, a user of client device 101 may wish to access protected resource 103. To do so the user may cause client device 101 to issue a request to access protected resource 103 to authentication agent 102. In response to the request, authentication agent 102 may issue an authentication request to client device 101. Consistent with the foregoing description, a response to the authentication request must comply with the authentication operations associated with a contextually sensitive security procedure enforced by authentication agent 102, before authentication agent 102 will grant access to protected resource 103. As will be discussed further below, client device 101 can leverage the capabilities of a multimode authentication module (MAM) shown in FIG. 2A and FIG. 2B to facilitate compliance with the requirements of the authentication request and the underlying CSSP/authentication operations.

As will be discussed further below in FIG. 2A and FIG. 2B, an MAM on client device 101 may monitor for authentication requests from an authentication agent governing access to a protected resource. Upon detection of an authentication request, the MAM may leverage information and resources available to it to determine contextual information which may govern which of the contextually dependent security policies and/or authentication operations imposed by the CSSP is required. Once the MAM determines relevant contextual information, it may use that information to select the appropriate security policy(ies) and/or authentication operation(s) required by the CSSP in a user transparent manner. The MAM may then execute the required security policy(ies) and/or authentication operations with the authentication agent in a transparent or substantially transparent manner. In this way the MAM can facilitate user authentication to the authentication agent so as to reduce, minimize, or even eliminate the need for a user to manually determine and comply with a CSSP governing access to a protected resource.

As used in any embodiment herein, the term “module” may refer to software, firmware and/or circuitry configured to perform one or more operations consistent with the present disclosure. Software may be embodied as a software package, code, instructions, instruction sets and/or data recorded on non-transitory computer readable storage mediums. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, software and/or firmware that stores instructions executed by programmable circuitry. The modules may, collectively or individually, be embodied as circuitry that forms a part of one or more devices, as defined previously.

Reference is now made to FIG. 2A, which depicts a block diagram of an exemplary client device consistent with the present disclosure. As shown, client device 101 may include platform 200, which is shown to include processor 201, multimode authentication module 210, memory 230, operating system 230, input/output (I/O) system 240, display element 250, network interface 260, and one or more sensor(s) 270, the operations of which are described herein. Any or all of such components may be coupled to one another via a bus (not labeled) or some other means.

Platform 200 may correlate to any device platform suitable for use with a client device, as described above. Accordingly, platform 106 may be configured, for example, in the form of a mobile device platform (e.g., a cellular handset or a smartphone), a mobile computing device platform (e.g., a tablet computer like an iPad®, Surface®, Galaxy Tab®, Kindle Fire®, etc., an Ultrabook® including a low-power chipset manufactured by Intel Corporation, a netbook, a notebook, a laptop or a palmtop), a desktop computer platform, a kiosk platform, a smart badge platform, combinations thereof and the like.

In platform 200, processor 201 may comprise one or more processors situated in separate components, or alternatively, one or more processing cores embodied in a single component (e.g., in a System-on-a-Chip (SoC) configuration) and any processor-related support circuitry (e.g., bridging interfaces, etc.). Example processors may include but are not limited to various x86-based microprocessors available from the Intel Corporation including those in the Pentium, Xeon, Itanium, Celeron, Atom, Core i-series product families, Advanced RISC (e.g., Reduced Instruction Set Computing) Machine or “ARM” processors, etc. Examples of support circuitry may include chipsets (e.g., Northbridge, Southbridge, etc. available from the Intel Corporation) configured to provide an interface through which processor 201 may interact with other system components that may be operating at different speeds, on different buses, etc. in platform 201. Some or all of the functionality commonly associated with the support circuitry may also be included in the same physical package as the processor (e.g., such as in the Sandy Bridge family of processors available from the Intel Corporation). It will be appreciated that in some embodiments, one or more of the components of platform 200 may be combined in a system-on-a-chip (SoC) architecture.

Memory 220 may include one or more of the following types of memory: semiconductor firmware memory, programmable memory, non-volatile memory, read only memory, electrically programmable memory, random access memory, flash memory (which may include, for example, NAND or NOR type memory structures), magnetic disk memory, and/or optical disk memory. Additionally or alternatively, memory 220 may include other and/or later-developed types of computer-readable memory. In some embodiments, memory 220 may be local to processor 201, local to MAM 210, and/or local to another embedded processor (not shown) within client device 101.

Operating system 230 may be any operating system suitable for execution on processor 201. Example operating systems that may be used include but are not limited to the Android® OS, iOS®, Windows® OS, Blackberry® OS, Palm® OS, Symbian® OS, Linux®, etc.

Input/output (I/O) system 240 may be any suitable system from inputting information to and outputting information from components of platform 200 and/or external components. Among other things, I/O system 240 may include components for inputting information into a host system such as client device 101. Non-limiting examples of such components include keyboards, computer mice, touchscreens, etc., combinations thereof, and the like. Similarly, I/O system 240 may include components for outputting information from platform 201, such as but not limited to graphics hardware (e.g., a graphics processing unit) which may output signals suitable for display by display element 250.

Display element 250 may be any display suitable for use in platform 200. In some embodiments, display element 250 is at least one of a touchscreen, a liquid crystal (LCD) display, a plasma display, an organoluminescent display, or other suitable display.

Network interface 260 may be configured to provide wired or wireless communication between platform 200 and any external entities, such as but not limited to authentication agent 102. Such communications may be made using wired or wireless communication, as previously described above in connection with FIG. 1.

Sensor(s) 270 may be any of a wide variety of sensors that are capable of detecting and reporting contextual information to MAM 210 and/or other components of platform 200. Non-limiting examples of suitable sensors that may be used include: location sensors such as global positioning sensors (GPS), geotracking sensors, cellular location tracking systems, and the like; environmental sensors such as infrared, visible, and/or stereoscopic cameras, temperature sensors, optical (light) detection systems, and the like; biometric sensors such as fingerprint scanners, iris scanners, palm vein scanners, facial recognition systems, deoxyribonucleic acid (DNA) analyzers, network sensors such as network analyzers, etc., combinations thereof, and the like. In general and as will be described in further detail below, sensor(s) 270 may operate to detect contextual information at the time a request to access a protected resource is made and/or when a CSSP governing a protected resource is enforced, and to report such information to MAM 210.

Among other things, MAM 210 is configured such that it is operable to securely and transparently authenticate a user of client device 101 to authentication agent 102, upon verification of the user the agent enters the necessary authentication information such as user ID and password so as to gain access to protected resource 103. MAM 210 may thus be configured such that it has knowledge of the protected resources governed by authentication agent 102, as well as the contextually sensitive policies and authentication operations that authentication agent 102 will enforce to govern access to protected resources 103. In addition, MAM 210 may have (or may gain) knowledge of the information needed to comply with the security policy(ies)/authentication operation(s) required by the CSSP in a given context, such as relevant context modifiers, credentials, user information, etc. Finally, the MAM may be configured to employ resources (e.g., sensor(s) 270, network interface 260 etc.) and information available to it to determine the context in which a request to access protected resource 103 is made, determine which security policy will be enforced by authentication agent 102 in view of that context, and execute the required authentication operations needed to comply with that security policy in a user friendly manner.

Reference is now made to FIG. 2B, which depicts one example of a MAM consistent with the present disclosure. As shown, MAM 210 includes user interface component (UI) 211, authentication engine 212, and vault 213, the operations of each of which will be described below.

UI 211 is generally configured to provide a mechanism through which a user may interact with and/or configure various components of MAM 210, including but not limited to authentication engine 212 and vault 213. For example, UI 211 may be utilized to pre-configure authentication engine 212 and/or vault 213, prior the use of MAM 210 to authenticate the user to an authentication agent. Alternatively or additionally, UI 211 may be used by authentication engine 212 to prompt a user for input of information that may be needed to comply with one or more security policies enforced by a CSSP, e.g., relevant credentials, user information, etc.

Authentication engine 212 is generally configured to service authentication requests issued by an authentication agent (e.g., authentication agent 102) in a way that is transparent or substantially transparent to a user of client device 101. More specifically, authentication engine 212 is configured to monitor for and intercept authentication requests issued from an authentication agent, e.g., which may be received at network interface 260 of client device 101.

Vault 213 may be a database or other data structure that stores a record of protected resources protected by one or more authentication agents (including authentication agent 102), contextually sensitive security procedures/policies that may govern access to such protected resources, context modifiers relevant to each protected resource/security procedure, and authentication operations associated with those security policies. Accordingly, vault 213 may be configured to store protected resource identifiers (resources 215) correlated to one or more security policy entries 216, and context modifiers 217. In addition, vault 213 may store information needed to satisfy all or a portion of security policy entries 216 governing one or more protected resources 215. For the sake of clarity, such information is referred to herein as “credentials” and is illustrated in FIG. 2B as credentials 214.

In some embodiments, vault 213 may also store other security modifiers 218, which may be exceptional security requirements imposed by a third party. Non-limiting examples of other security modifiers include requirements to comply with secondary authentication requests, such as entry of a single use credential (e.g., CAPTCHA), entry of biometric information, combinations thereof, and the like

Vault 213 may in some embodiments be pre-configured prior to the use of MAM 210 to perform authentication operations consistent with the present disclosure. For example when MAM 210 is initially executed (e.g., booted) on a client device, authentication engine 212 may utilize UI 211 to prompt a user to configure vault 213. More specifically, authentication engine 212 may cause UI 211 to prompt a user to identify protected resources that he/she wishes to access, identify security policies associated with those resources, provide authentication information (e.g., credentials), etc. relevant to those protected resources, etc. In some embodiments, pre-configuration operations of MAM 210 may be guided by a record of a user's prior history, e.g., to access certain protected resources, comply with certain security policies, etc. Applying such history, MAM 210 may intelligently use UI 211 to prompt a user for access and other (e.g., security) information pertaining to previously accessed protected resources, as well as to prompt for the input of access and security information for which the user plans to request access for the first time (or for which no user history exists).

In any case, authentication engine 212 may store user inputs made through UI 211 in vault 213, e.g. for use in servicing authentication requests issued from authentication agent 102. Thus for example, a user may input, via UI 211, protected resource identifiers 215, security policy entries 216 and context modifiers 217 relevant to security policies that protect resources identified by such resource identifiers, and/or credentials 214 which may be used to perform authentication operations associated with such security policies. Authentication engine 212 may store this information in vault 213, as generally illustrated in FIG. 2B.

Of course, vault 213 need not be pre-configured with information needed to service an authentication request, and even if it is pre-configured vault 213 may not contain the information needed to service an authentication request. In such instances, authentication engine 212 may be configured to determine what elements are required to service an authentication request issued from authentication agent 102, and to prompt a user (e.g., through UI 211) for entry of such information. Authentication engine 212 may then store entered responses to such prompts in vault 213. In this way, authentication engine may dynamically update and/or populate vault 213.

As noted previously, authentication engine 212 is configured to monitor for the receipt of authentication requests, and to service those requests in a transparent or substantially transparent manner. In this regard authentication engine 212 may be configured to monitor network interface 260 and/or I/O system 240 for the receipt of an authentication request from authentication agent 102. As noted previously, such authentication request may have been generated by authentication agent 102 in response to a request issued by client device 101 to access protected resource 103.

Upon detection of an authentication request, authentication engine 212 may leverage information and resources available to it to determine how to respond. For example, authentication engine 212 may analyze an authentication request to determine if it contains information identifying a specific security policy that is being enforced by authentication agent 102 to govern access to protected resource 103.

Alternatively or additionally, authentication engine 212 may use other information to determine which security policy(ies) will be enforced by authentication agent 102 to govern access to protected resource 103. For example, authentication engine 212 may utilize information contained in the request to access protected resource 103, information in vault 213, and/or contextual information gleaned from sensor(s) 270, network interface 260, I/O system 240, etc. to determine the relevant security policy enforced by authentication agent 102.

In one example embodiment, vault 213 may include a record of protected resources 215, each of which is correlated to a plurality of security policy entries 216 and context modifiers 217, as noted previously. With this in mind, authentication engine 212 may be configured such that it can determine which security policy will be enforced over a particular protected resource if it has two pieces of information, namely the identity of the resource and relevant contextual modifiers that were present or true at the time the request to access the protected resource was issued.

Authentication engine 212 may be configured to determine the identity of the protected resource for which access is being requested from the content of the access request itself, or in some other manner. In some embodiments, authentication engine is configured to analyze a request to access a protected resource for a resource identifier or other identification tag, so as to identify the protected resource targeted by the request.

Before, during or after authentication engine 212 determines the identity of the targeted protected resource, it may utilize resources available to it such as sensors 270, network interface 260, I/O system 240, etc., to determine contextual information (e.g., location, user identification, user presence, etc.) were present or “true” at the time the request to access protected resource 103 was issued. Without limitation, authentication engine 212 may be preferably configured to query vault 213 to determine which contextual modifiers are relevant to a targeted protected resource, prior to querying other resources for relevant contextual information. In this way, authentication engine may tailor its queries for contextual information (e.g., from sensors 270, I/O system 240, network interface 260) so as to retrieve information that is relevant to context modifiers that are associated with a protected resource, and potentially to avoid unnecessary collection of contextual information that is irrelevant (e.g., not used in) a security policy governing access to a targeted protected resource.

Provided vault 213 includes an entry for the targeted protected resource, Authentication engine 212 may cross reference the identity of the targeted protected resource and known contextual information against the content of vault 213 to determine which security policy(ies) and/or procedures govern access to the protected resource. More specifically, authentication engine 212 may use the identity of the targeted resource to identify which protected resource identifier in vault 213 is applicable. Authentication engine may then compare contextual information gleaned, e.g., from sensor(s) 270 and/or network interface 260 against the context modifiers 217 associated with the identified protected resource identifier.

Based on that comparison, authentication engine 213 may determine which security policy(ies) are being enforced over the protected resource, and which authentication operations are associated with that security policy or policies. Authentication engine 212 may make such determination, for example, based on a direct comparison of known contextual information to the context modifiers in vault 213 associated with the targeted resource. Alternatively or additionally, authentication engine may make such a determination through inferential and/or logical reasoning supported by the known contextual information and context modifiers correlated to the targeted resource in vault 213.

Having determined the security policy(ies) and/or authentication operation(s) that are required to comply with an authentication request, authentication engine 212 may determine whether or not it has knowledge of the credentials needed to service the authentication request. In this regard, authentication engine 212 may query vault 213 to determine whether the credentials needed to service the authentication request is present. If the required credentials are not present in vault 213, authentication engine 212 may cause UI 211 to prompt a user for entry of the required credentials. If a user enters such credentials, authentication engine 212 may update vault 213 to associate the entered credentials with the targeted protected resource and/or relevant security policy(ies). In this way, authentication engine 212 may dynamically update vault 213 to associate newly entered credentials with one or more protected resources.

It is expected that in at least some instances, vault 213 may not contain an entry for a protected resource for which access is being sought, and/or it may lack information regarding the security policies, context modifiers, and credentials relevant to the security policy enforced over the protected resource. In such instances, authentication engine 212 may utilize prompt a user to input any of such information, e.g., via UI 211. Authentication engine 212 may then use such information to determine which security policy(ies) is/are being enforced by authentication agent 102.

Once authentication engine 212 has knowledge of the credentials needed to respond to an authentication request and the security policy(ies) enforced by authentication agent 102, it may attempt to service the authentication request in a manner consistent with the relevant security policy(ies). For example, authentication engine 212 may communicate the required credentials to authentication agent 102, e.g., via network interface 260. Authentication engine 212 may tailor the communication of credentials in such a way as to comply with timing, entry, or other requirements that may be imposed by the security policy enforced by authentication agent 102.

As may be clear from the foregoing discussion, MAM 210 may transparently or substantially transparently execute operations that are needed to comply with the security policy(ies) and/or authentication operations that are enforced by authentication agent 102 with respect to a targeted protected resource. In this way MAM 210 can facilitate user authentication to the authentication agent so as to reduce, minimize, or even eliminate the need for a user to manually determine and comply with a CSSP governing access to a protected resource.

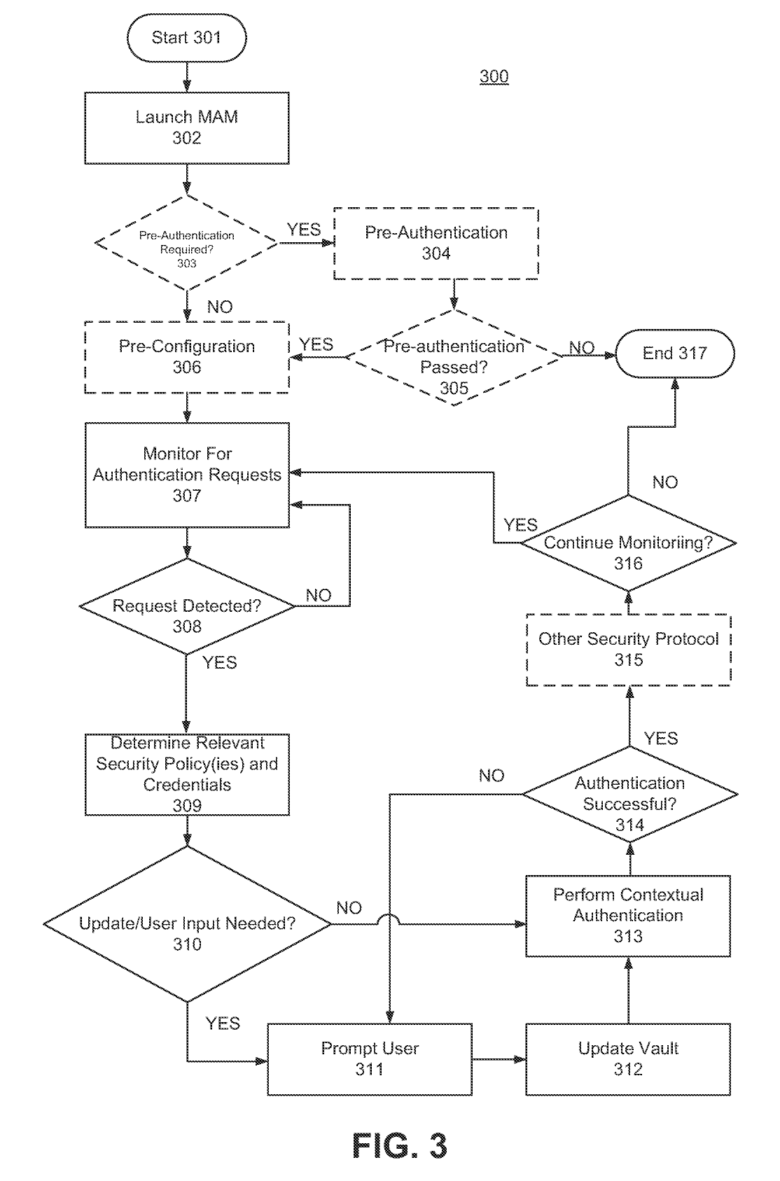

Another aspect of the present disclosure relates to methods for authenticating a client device to an authentication agent that governs access to a protected resource with a CSSP. Reference is therefore made to FIG. 3, which depicts a flowchart of exemplary operations consistent with one example method in accordance with the present disclosure.

As shown, method 300 starts at block 301. At block 302, a multimode authentication module (MAM) may be launched. After such launch, the method may proceed to optional block 303, wherein a determination is made as to whether compliance with a pre-authentication process is required before use of the MAM will be permitted. In this regard, use of an MAM may be preconditioned on the successful completion of another authentication process, such as may be used to verify user identity and/or authenticity of the client device upon which the MAM is being executed. Examples of suitable pre-authentication processes include biometric authentication, previous manual compliance with one or more security policies governing protected resources, compliance with overarching enterprise authentication requirements, previous manual entry of relevant credentials, successful attestation of the client platform to another entity (e.g., a trusted authentication service), compliance with one or more passive authentication procedures (e.g., which may determine user presence and/or user identification based on biometrics, passive detection mechanisms, heuristics, etc.) combinations thereof and the like.

If compliance with a pre-authentication process is required, the method may proceed to optional block 304, wherein the relevant pre-authentication process is performance. The method may proceed to optional block 305, wherein a determination is made as to whether the pre-authentication process successfully completed. If not, the method may proceed to block 317 and end. If so, or if pre-authentication is not required, the method may proceed to optional block 306.

At optional block 306, the MAM may optionally be preconfigured as generally discussed above in connection with FIG. 2B. That is, prior to its use, an authentication engine and vault within the MAM may be configured by a user, e.g., using an appropriate user interface. Pre-configuration may include, for example, entering resource identifiers for a pool of protected resources into the MAM's vault, along with relevant security policies, context modifiers, and/or credentials associated with all or a subset of the resource identifiers.

Once pre-configuration is complete or if pre-configuration is not required, the method may proceed to block 307, wherein the MAM monitors for receipt of an authentication request, e.g., from an authentication agent. As noted above, the authentication request may be issued by an authentication agent in response to a request to access a protected resource that was issued from a client device or some other source.

The method may then proceed to block 308, wherein a determination may be made as to whether an authentication request has been detected. If not, the method may loop back to block 307 and the MAM may continue to monitor for receipt of an authentication request.

If an authentication request is detected, the method may proceed to block 309, wherein the MAM may intercept the request, and determine which security policy(ies) are being enforced by the authentication agent in connection with the request to access the protected resource. As discussed previously, the MAM may determine which security policy applies by determining the identity of the target resource and contextual information that was true at the time the access request was issued (or at another relevant time), and cross referencing that information with protected resource identifiers and associated context modifiers stored in a vault of the MAM. In addition, the MAM may determine whether its vault contains the credentials needed to response to the authentication request in a manner consistent with the relevant security policy(ies) governing the target protected resource.

Regardless of whether the MAM is able to determine which security policy applies (e.g., due to a lack of contextual information, lack of a protected resource identifier, lack of relevant context modifiers, etc. in the vault) and/or is possession of the relevant credentials, the method may proceed to block 310, wherein a determination may be made as to whether an update to the MAM's vault is needed. If an update is needed (e.g., where the vault lacks an entry for the target resource, relevant security policy(ies), relevant context modifiers, relevant credentials, etc.), the method may proceed to blocks 311 and 312, wherein the MAM may issue a prompt to enter the desired information and store the entered information in its vault, respectively.

Once an update to the vault is complete or if no vault update is required, the method may proceed to block 313, wherein the MAM may respond to the authentication request in a manner consistent with the security policy(ies) enforced by the authentication agent governing access to the protected resource, as generally discussed above. The method may then proceed to block 314, wherein a determination may be made as to whether authentication of the user/client device to the authentication agent was successful. If not, the method may loop back to block 311, wherein the MAM may issue a prompt for entry of updated credentials and/or other information needed to comply with the relevant security policy(ies).

The method may then proceed to optional block 315, wherein secondary security requirements may be performed, if required. For example, the authentication agent or another authentication entity may require a user to manually enter a one-time use password before access to a protected resource will be granted. If performance of the secondary authentication requirements is completed successfully or if secondary authentication is not required, the method may proceed to bock 316, wherein a determination may be made as to whether the MAM is to continue monitoring for the receipt of authentication requests. If so, the method may loop back to block 307 and repeat. If not, the method may proceed to block 317 and end.

Embodiments of the methods described herein may be implemented in a system that includes one or more computer readable storage mediums having stored thereon, individually or in combination, instructions that when executed by one or more processors perform the methods described herein. Here, the processor may include, for example, a system CPU (e.g., core processor) and/or programmable circuitry. Thus, it is intended that operations according to the methods described herein may be distributed across a plurality of physical devices, such as processing structures at several different physical locations. Also, it is intended that the method operations may be performed individually or in a sub combination, as would be understood by one skilled in the art. Thus, not all of the operations of each of the flow charts need to be performed, and the present disclosure expressly intends that all sub combinations of such operations are enabled as would be understood by one of ordinary skill in the art.

The computer readable storage medium may include any type of tangible medium, for example, any type of disk including floppy disks, optical disks, compact disk read-only memories (CD-ROMs), compact disk rewritables (CD-RWs), digital versatile disks (DVDs) and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of media suitable for storing electronic instructions.

“Circuitry”, as used in any embodiment herein, may comprise, for example, singly or in any combination, hardwired circuitry, programmable circuitry, state machine circuitry, and/or firmware that stores instructions executed by programmable circuitry. An “application” (app), “agent” or “service” may be embodied as code or instructions which may be executed on programmable circuitry such as a host processor or other programmable circuitry and may, in some embodiments, work in conjunction with or as a component of an Operating System. A module, as used in any embodiment herein, may be embodied as circuitry. The circuitry may be embodied as an integrated circuit, such as an integrated circuit chip.

Thus, the present disclosure provides devices, methods, systems and computer-readable storage medium for authenticating a client device and/or user to an authentication agent that governs access to a protected resource using a contextually sensitive security procedure. As may be appreciated, the technologies described herein may perform such authentication in a manner that is transparent or substantially transparent to a user of a client device. That is, the technologies may limit or avoid the need for manual performance of authentication operations that may be required by a contextually sensitive security policy.

The following examples pertain to additional embodiments of the present disclosure.

### EXAMPLES

### Example 1

According to this example there is provided a system for performing authentication operations, including: a client device configured to issue a request to access a protected resource protected by a contextually sensitive security procedure enforced by an authentication agent, the client device including a multimode authentication module, wherein the multimode authentication module is to: determine which of a plurality of security policies within the contextually sensitive security procedure is being enforced by the authentication agent to govern access to the protected resource; and perform authentication operations consistent with the security policy or policies enforced by the contextually sensitive security procedure to authenticate at least one of the client device and a user of the client device to the authentication agent, so as to gain access to the protected resource.

### Example 2

This example includes any or all of the features of example 1, wherein the multimode authentication module is further configured to intercept an authentication request received from the authentication agent, the authentication request being issued in response to the request to access a protected resource.

### Example 3

This example includes any or all of the features of example 1, wherein the multimode authentication module includes an authentication engine and a vault, wherein the authentication engine is to determine which of the security policies is being enforced by the authentication agent based at least in part on information stored in the vault.

### Example 4

This example includes any or all of the features of example 3, wherein the information stored in the vault includes a data structure correlating a protected resource identifier corresponding to the protected resource with a plurality of context modifiers, the plurality of context modifiers being correlated to a plurality of security policy entries, the security policy entries correlating to one or more of the security policies in the contextually sensitive security procedure.

### Example 5

This example includes any or all of the features of example 4, wherein: the client device further includes one or more sensors configured to detect contextual information at the time the request to access was made and to report the contextual information to the multimode authentication module; the multimode authentication module determines which of the security policies is being enforced by the authentication agent based at least in part on the contextual information.

### Example 6

This example includes any or all of the features of example 5, wherein the multimode authentication module determines which of the context modifiers is true based at least in part on the contextual information, and determines which of the security policies is being enforced by the authentication agent based at least in part on a combination of context modifiers that are true and the protected resource identifier.

### Example 7

This example includes any or all of the features of example 4, wherein: the vault further stores credentials, the credentials being correlated to one or more of the security policy entries, and the authentication engine utilizes the credentials in the performance of the authentication operations.

### Example 8

This example includes any or all of the features of example 3, wherein before or after the authentication request is intercepted, the authentication engine is configured to prompt a user of the client device to enter in the information for storage in the vault.

### Example 9

This example includes any or all of the features of example 8, wherein the multimode authentication module further includes a user interface, and the authentication engine prompts the user to enter the information via the user interface.

### Example 10

This example includes any or all of the features of example 3, wherein the security policy or policies enforced by the authentication agent require performance of a secondary authentication procedure, and the authentication engine is configured to prompt a user of the client device to comply with the secondary authentication procedure in connection with the performance of the authentication operations.

### Example 11

This example includes any or all of the features of example 10, wherein the secondary authentication procedure requires manual entry of a one-time use password.

### Example 12

According to this example there is provided a method of performing authentication operations, including: intercepting, with a multimode authentication module of a client device, an authentication request issued from an authentication agent enforcing a contextually sensitive security procedure; determining with the multimode authentication module which of a plurality of security policies in the contextually sensitive security procedure is being enforced to govern access to a protected resource; and performing authentication operations associated with the security policy or policies enforced by the contextually sensitive security procedure to authenticate at least one of the client device and a user thereof to the authentication agent, so as to gain access to the protected resource.

### Example 13

This example includes any or all of the features of example 12, and further includes: issuing a request to access the protected resource to the authentication agent from the client device; and monitoring, with the multimode authentication module, for the receipt of the authentication request in response to the request to access the protected resource.

### Example 14

This example includes any or all of the features of example 12, wherein the multimode authentication module includes an authentication engine and a vault, and the method further includes: determining with the authentication engine which of the security policies is being enforced by the authentication agent based at least in part on information stored in the vault.

### Example 15

This example includes any or all of the features of example 14, wherein the information stored in the vault includes a data structure correlating a protected resource identifier corresponding to the protected resource with a plurality of context modifiers, the plurality of context modifiers being correlated to a plurality of security policy entries, the security policy entries correlating to one or more of the security policies in the contextually sensitive security procedure.

### Example 16

This example includes any or all of the features of example 15, wherein the client device further includes one or more sensors, wherein the method further includes: detecting contextual information with the sensors at the time the request to access is made; determining, with the multimode authentication module, which of the context modifiers is true based at least in part on the contextual information.

### Example 17

This example includes any or all of the features of example 16, and further includes: determining which of the security policies are being enforced by the authentication agent based at least in part on a combination of true context modifiers and the protected resource identifier.

### Example 18

This example includes any or all of the features of example 14, wherein the vault further stores credentials that are correlated to one or more of the security policy entries, and the method further includes using the credentials in the performance of the authentication operations with the authentication engine.

### Example 19

This example includes any or all of the features of example 14, and further includes: prompting, with the authentication engine, a user of the client device to enter the information.

### Example 20

This example includes any or all of the features of example 19, wherein the multimode authentication module further includes a user interface, and the authentication engine performs the prompting at least in part with the user interface.

### Example 21

This example includes any or all of the features of example 14, wherein the security policy or policies enforced by the authentication agent require performance of a secondary authentication procedure, and the method further includes: prompting, with the authentication engine, a user of the client device to comply with the secondary authentication procedure in connection with the performance of the authentication operations.

### Example 22

This example includes any or all of the features of example 21, wherein the secondary authentication procedure requires manual entry of a one-time use password.

### Example 23

According to this example there is provided a computer-readable storage medium having instructions stored thereon which when executed by a processor of a client device cause the client device to perform the following operations including: intercepting an authentication request issued from an authentication agent enforcing a contextually sensitive security procedure; determining which of a plurality of security policies in the contextually sensitive security procedure is being enforced to govern access to a protected resource; and performing authentication operations associated with the security policy or policies enforced by the contextually sensitive security procedure to authenticate at least one of the client device and a user thereof to the authentication agent, so as to gain access to the protected resource.

### Example 24

This example includes any or all of the features of example 23, wherein the instructions when executed further cause the client device to perform the following operations including: issuing a request to access the protected resource to the authentication agent from the client device; and monitoring for the receipt of the authentication request in response to the request to access the protected resource.

### Example 25

This example includes any or all of the features of example 23, wherein the instructions when executed cause the client device to perform the following additional operations including: determining which of the security policies is being enforced by the authentication agent based at least in part on information stored in a vault of the client device.

### Example 26

This example includes any or all of the features of example 25, wherein the information stored in the vault includes a data structure correlating a protected resource identifier corresponding to the protected resource with a plurality of context modifiers, the plurality of context modifiers being correlated to a plurality of security policy entries, the security policy entries correlating to one or more of the security policies in the contextually sensitive security procedure.

### Example 27

This example includes any or all of the features of example 26, wherein the client device further includes one or more sensors, and the instructions when executed further cause the client device to perform the following operations including: detecting contextual information with the sensors at the time the request to access is made; determining which of the context modifiers is true based at least in part on the contextual information.

### Example 28

This example includes any or all of the features of example 27, wherein the instructions when executed further cause the client device to perform the following operations including: determining which of the security policies are being enforced by the authentication agent based at least in part on a combination of true context modifiers and the protected resource identifier.

### Example 29

This example includes any or all of the features of example 26, wherein the vault further stores credentials that are correlated to one or more of the security policy entries, and the instructions when executed further cause the client device to perform the following operations including: using the credentials in performing the authentication operations with the authentication engine.

### Example 30

This example includes any or all of the features of example 26, wherein the instructions when executed further cause the client device to perform the following operations including: prompting, with the authentication engine, a user of the client device to enter the information.

### Example 31

This example includes any or all of the features of example 30, wherein the client device further includes a user interface, and the instructions when executed further cause the client device to perform the prompting at least in part with the user interface.

### Example 32

This example includes any or all of the features of example 25, wherein the security policy or policies enforced by the authentication agent require performance of a secondary authentication procedure, and the instructions when executed further cause the client device to perform the following operations including: prompting, with the authentication engine, a user of the client device to comply with the secondary authentication procedure in connection with the performance of the authentication operations.

### Example 33

This example includes any or all of the features of example 32, wherein the secondary authentication procedure requires manual entry of a one-time use password.

### Example 34

According to this example there is provided a system for performing authentication operations, including: means to issue a request to access a protected resource protected by a contextually sensitive security procedure enforced by a authentication agent from a client device, means to determine which of a plurality of security policies within the contextually sensitive security procedure is being enforced by the authentication agent to govern access to the protected resource; and means to perform authentication operations consistent with the security policy or policies enforced by the contextually sensitive security procedure to authenticate at least one of the client device and a user of the client device to the authentication agent, so as to gain access to the protected resource.

### Example 35

This example includes any or all of the features of example 34, further including means to intercept an authentication request received from the authentication agent, the authentication request being issued in response to the request to access a protected resource.

### Example 36

This example includes any or all of the features of example 34, wherein the client device further includes a vault, and the system further includes means to determine which of the security policies is being enforced by the authentication agent based at least in part on information stored in the vault.

### Example 37

This example includes any or all of the features of example 36, wherein the information stored in the vault includes a data structure correlating a protected resource identifier corresponding to the protected resource with a plurality of context modifiers, the plurality of context modifiers being correlated to a plurality of security policy entries, the security policy entries correlating to one or more of the security policies in the contextually sensitive security procedure.

### Example 38

This example includes any or all of the features of example 37, further including means to detect contextual information at the time the request to access was made, wherein the means to determine which of the security policies is being enforced by the authentication agent makes such determination based at least in part on the contextual information.

### Example 39

This example includes any or all of the features of example 38, wherein the means to determine which of the security policies is being enforced by the authentication agent determines which of the context modifiers is true based at least in part on the contextual information, and determines which of the security policies is being enforced by the authentication agent based at least in part on a combination of context modifiers that are true and the protected resource identifier.

### Example 40

This example includes any or all of the features of example 37, wherein: the vault further stores credentials, the credentials being correlated to one or more of the security policy entries, and the means to perform authentication operations utilizes the credentials to authenticate at least one of the client and a user thereof to the authentication agent.

### Example 41

This example includes any or all of the features of example 36, further including means to prompt a user of the client device to enter in the information for storage in the vault, before or after receipt of the authentication request.

### Example 42

This example includes any or all of the features of example 41, wherein the means to prompt a user includes a user interface.

### Example 43

This example includes any or all of the features of example 36, wherein the security policy or policies enforced by the authentication agent require performance of a secondary authentication procedure, and the system further includes means to prompt a user of the client device to comply with the secondary authentication procedure in connection with the performance of the authentication operations.

### Example 44

This example includes any or all of the features of example 43, wherein the secondary authentication procedure requires manual entry of a one-time use password.

### Example 45

According to this example there is provided a computer-readable storage medium having instructions stored thereon which when executed by a processor of a client device cause the client device to perform the method of any one of examples 12 to 22.

### Example 46

According to this example there is provided an apparatus including means to perform the method of any one of examples 12 to 22.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

1-25. (canceled)

26. A system for performing authentication operations, comprising:
a client device configured to issue a request to access a protected resource protected by a contextually sensitive security procedure enforced by an authentication agent, the client device comprising a multimode authentication module, wherein said multimode authentication module comprises an authentication engine and a vault, wherein said multimode authentication module is to:
intercept an authentication request received from said authentication agent;
determine with said authentication engine which of a plurality of security policies within said contextually sensitive security procedure is being enforced by said authentication agent to govern access to said protected resource, based at least in part on information stored in said vault; and
perform authentication operations consistent with the security policy or policies enforced by said contextually sensitive security procedure to authenticate at least one of said client device and a user of said client device to said authentication agent, so as to gain access to said protected resource.

27. The system of claim 26, wherein said information stored in said vault comprises a data structure correlating a protected resource identifier corresponding to said protected resource with a plurality of context modifiers, said plurality of context modifiers being correlated to a plurality of security policy entries, said security policy entries correlating to one or more of said security policies in said contextually sensitive security procedure.

28. The system of claim 27, wherein:
said client device further comprises one or more sensors configured to detect contextual information at the time said request to access was made and to report said contextual information to said multimode authentication module;
said multimode authentication module determines which of said security policies is being enforced by said authentication agent based at least in part on said contextual information.

29. The system of claim 28, wherein said multimode authentication module determines which of said context modifiers is true based at least in part on said contextual information, and determines which of said security policies is being enforced by said authentication agent based at least in part on a combination of context modifiers that are true and said protected resource identifier.

30. The system of claim 27, wherein:
said vault further stores credentials, said credentials being correlated to one or more of said security policy entries, and
said authentication engine utilizes said credentials in the performance of said authentication operations.

31. The system of claim 27, wherein before or after said authentication request is intercepted, said authentication engine is configured to prompt a user of the client device to enter in said information for storage in said vault.

32. The system of claim 27, wherein said security policy or policies enforced by said authentication agent require performance of a secondary authentication procedure, and said authentication engine is configured to prompt a user of the client device to comply with the secondary authentication procedure in connection with said performance of said authentication operations.

33. A method of performing authentication operations, comprising:
intercepting, with a multimode authentication module (multimode authentication module) of a client device, an authentication request issued from an authentication agent enforcing a contextually sensitive security procedure, said multimode authentication module comprising an authentication engine and a vault;
determining with said multimode authentication module which of a plurality of security policies in said contextually sensitive security procedure is being enforced to govern access to a protected resource based at least in part on information stored in said value; and
performing authentication operations associated with said security policy or policies enforced by said contextually sensitive security procedure to authenticate at least one of said client device and a user thereof to said authentication agent, so as to gain access to said protected resource.

34. The method of claim 33, further comprising:
issuing a request to access said protected resource to said authentication agent from said client device; and
monitoring, with said multimode authentication module, for the receipt of said authentication request in response to said request to access said protected resource.

35. The method of claim 33, wherein said information stored in said vault comprises a data structure correlating a protected resource identifier corresponding to said protected resource with a plurality of context modifiers, said plurality of context modifiers being correlated to a plurality of security policy entries, said security policy entries correlating to one or more of said security policies in said contextually sensitive security procedure.

36. The method of claim 35, wherein said client device further comprises one or more sensors, the method further comprising:
detecting contextual information with said sensors at the time said request to access is made;
determining, with said multimode authentication module, which of said context modifiers is true based at least in part on said contextual information.

37. The method of claim 36, further comprising:
determining which of said security policies are being enforced by said authentication agent based at least in part on a combination of true context modifiers and said protected resource identifier.

38. The method of claim 33, wherein said vault further stores credentials that are correlated to one or more of said security policy entries, and
said method further comprises using said credentials in the performance of said authentication operations with said authentication engine.

39. The method of claim 33, further comprising:
prompting, with said authentication engine, a user of the client device to enter said information.

40. The method of claim 33, wherein said security policy or policies enforced by said authentication agent require performance of a secondary authentication procedure, and the method further comprises:
prompting, with said authentication engine, a user of the client device to comply with the secondary authentication procedure in connection with said performance of said authentication operations.

41. A computer-readable storage medium having instructions stored thereon which when executed by a processor of a client device cause said client device to perform the following operations, comprising:
intercepting an authentication request issued from an authentication agent enforcing a contextually sensitive security procedure;
determining which of a plurality of security policies in said contextually sensitive security procedure is being enforced to govern access to a protected resource based at least in part on information in a vault of said client device; and
performing authentication operations associated with said security policy or policies enforced by said contextually sensitive security procedure to authenticate at least one of said client device and a user thereof to said authentication agent, so as to gain access to said protected resource.

42. The computer-readable storage medium of claim 41, wherein said instructions when executed further cause said client device to perform the following operations comprising:
issuing a request to access said protected resource to said authentication agent from said client device; and
monitoring for the receipt of said authentication request in response to said request to access said protected resource.

43. The computer-readable storage medium of claim 41, wherein said information stored in said vault comprises a data structure correlating a protected resource identifier corresponding to said protected resource with a plurality of context modifiers, said plurality of context modifiers being correlated to a plurality of security policy entries, said security policy entries correlating to one or more of said security policies in said contextually sensitive security procedure.

44. The computer-readable storage medium of claim 43, wherein said client device further comprises one or more sensors, and said instructions when executed further cause said client device to perform the following operations comprising:
detecting contextual information with said sensors at the time said request to access is made;
determining which of said context modifiers is true based at least in part on said contextual information; and
determining which of said security policies are being enforced by said authentication agent based at least in part on a combination of true context modifiers and said protected resource identifier.

45. The computer-readable storage medium of claim 41, wherein said vault further stores credentials that are correlated to one or more of said security policy entries, and said instructions when executed further cause said client device to perform the following operations comprising:
using said credentials in performing said authentication operations with said authentication engine.
